(19) United States
(12) Patent Application Publication
(10) Pub. No.: US 2012/0321421 A1
(43) Pub. Date: Dec. 20, 2012

(54) APPARATUS AND METHOD FOR CONVEYING BULK MATERIALS

(76) Inventor: CLAUDE LAVOIE, Sherwood Park (CA)

(21) Appl. No.: 13/523,948

(22) Filed: Jun. 15, 2012

Related U.S. Application Data
(60) Provisional application No. 61/498,242, filed on Jun. 17, 2011.

(51) Int. Cl. B60P 1/04; B65G 67/24; B65G 53/42; B60P 1/30

(52) U.S. Cl. 414/477; 414/482; 414/812; 406/194

(57) ABSTRACT

An apparatus and method for conveying granular and powered bulk materials is provided. The apparatus can include a trailer having a trailer bed that can tilt or rotate from a substantially horizontal position to an inclined position. The apparatus can further include a container that can be placed on the trailer bed for transport. The container can include a gate at one end to allow bulk material contained therein to exit the container when the gate is opened and the trailer bed is tilted or rotated to the inclined position. The apparatus can further include a pneumatic conveyor having a feed hopper to receive bulk material and to move the bulk material into a fluidizing chamber wherein pressurized air or gas flowing through the chamber conveys the bulk material.

### CROSS-REFERENCE TO RELATED APPLICATION

This application claims priority of U.S. Provisional Patent Application Ser. No. 61/498,242, entitled “Apparatus and Method for Conveying Bulk Materials”, filed Jun. 17, 2011, and hereby incorporates the same provisional application by reference herein in its entirety.

### TECHNICAL FIELD

The present disclosure is related to the field of machinery used for the transport and conveying of bulk granular and powdered materials and, in particular, tilting trailers for carrying containers configured for holding and dispensing granular or powdered materials into a pneumatic bulk material conveyor for conveying the materials to a silo or other location.

### BACKGROUND

Bulk granular powdered materials are used in construction, industrial, mining and well drilling operations, among other applications. Transporting such materials to sites where they are used can present challenges, both in the transport of the materials from the location where they are acquired to the site where they are to be used and in the conveying of the materials from the transport vehicle to a silo, container or pile where they are stored at the site itself.

There presently exist a number of vehicles, such as trailers, that can carry a container with means for unloading the contents of the container, such as particulate or fine matter. Most such trailers, however, use rotary valves having a plurality of vanes that have the potential to degrade the contents as it is dispensed through these valves. There is also the potential for the valves to clog up with material, such as fine material, and therefore make the discharge process inefficient as well as time consuming, especially when the valves need to be freed of the clogged material. This takes time and increases the cost of maintaining the discharge apparatus.

International Patent Application No. PCT/AU2004/001245 published under International Publication Number WO 2005/056441 published on 23 Jun. 2005, which is incorporated by reference into this application in its entirety, describes a pneumatic material delivery apparatus and method by providing a trailer with a tilting container that can feed bulk fine materials into a pneumatic cyclonic material conveyor.

U.S. Pat. No. 5,096,336 issued to Merrett et al. on Mar. 17, 1992, which is incorporated by reference into this application in its entirety, describes a tilting trailer for transporting containers loaded with particulate lading. A rotary valve in a hopper receiving gravity fed materials from a container feeds the material into a high velocity air stream.

U.S. Pat. No. 4,875,811 issued to Merrett et al. on Oct. 24, 1989, which is incorporated by reference into this application in its entirety, also describes a tilting trailer for transporting containers loaded with particulate lading. A rotary valve in a hopper receiving gravity fed materials from a container feeds the material into a high velocity air stream.

Japanese Patent Document No. 2007-326443 dated Dec. 20, 2007, which is incorporated by reference into this application in its entirety, describes a tilting trailer for transporting containers loaded with granular materials. A rotary feeder and a blower are driven to constantly transfer granular materials from a container to a storage tank via a receiving pipe.

U.S. Pat. No. 5,190,432 issued to Gerow on Mar. 2, 1993, which is incorporated by reference into this application in its entirety, describes a tilting trailer for transporting containers loaded with stones. The container has a sliding gate for releasing stones contained therein when the trailer is tilted. The container also has internal vertical walls for funnelling stones towards the gate.

Canadian Patent No. 2,057,916 issued to Herman et al. on Nov. 16, 1993, which is incorporated by reference into this application in its entirety, describes a pneumatic conveyor for various bulk materials that does not require the use of a rotary valve.

Canadian Patent Application No. 2,096,699 filed by Herman et al. and published on Nov. 28, 1993, which is incorporated by reference into this application in its entirety, also describes a pneumatic conveyor for various bulk materials that does not require the use of a rotary valve.

For the purposes of this application, the term “pneumatic conveyor” shall mean all of the embodiments of the pneumatic conveying device disclosed in Canadian Patent No. 2,057,916 and Canadian Patent Application No. 2,096,699.

The shortcomings of the prior art are that they do not provide a cost-effective and efficient apparatus and method for conveying granular bulk materials that do not include rotary valves or cyclonic feeders.

It is, therefore, desirable to provide an apparatus and method of conveying bulk materials that overcomes the shortcomings of the prior art.

### SUMMARY

An apparatus and method for conveying bulk materials is provided.

In some embodiments, a trailer can be used, such as end dump trailer, for hauling and transporting a container configured for containing granular or powered bulk materials. These materials can include cement, sand, fracturing sand, sandblasting sand, fertilizer, grain, gypsum, plaster and any other granular or powered bulk materials as well known to those skilled in the art.

In some embodiments, the trailer can comprise an end dump trailer, meaning a trailer having a frame with at least one axle and wheels rotatably attached thereto, and a trailer bed rotatably or tiltably attached to the frame wherein the trailer bed can move from a substantially horizontal position to an inclined position. In other embodiments, the trailer bed can be integral to the trailer, and the trailer comprising means for raising the trailer on one end to place the trailer bed in the inclined position. In some embodiments, the apparatus can comprise a container that can be placed and transported on the trailer bed. In some embodiments, the trailer can be attached to a motor vehicle, such as a highway tractor, for hauling the trailer and the container disposed thereon.

In some embodiments, the container can comprise a standard 8′×8′×20′ shipping container configured for holding or storing granular or powered bulk materials. In some embodiments, the container can comprise a sliding gate at one end thereof to allow bulk materials exit the container when the gate is opened and the trailer bed is moved to an inclined position. In further embodiments, the container can further comprise at least one vertical wall configured to funnel the bulk material contained in the container towards the gate when the trailer bed in the inclined position. In some embodiments, the container can comprise means for fluidizing the bulk material contained in the container to assist the bulk material in exiting the container through the gate. In some embodiments, the fluidizing means can comprise an air nozzle disposed on the at least one vertical wall configured to release pressurized air or inert gas into the bulk material contained in the container as a means to get the bulk material to flow like a fluid through the gate.

In some embodiments, the apparatus can comprise a pneumatic conveyor further comprising a feed hopper, the pneumatic conveyor disposed on the trailer bed wherein bulk material exiting the container can feed into the feed hopper.

In some embodiments, the trailer bed can be integral to a motor vehicle, such as a large truck, wherein the trailer bed can be substituted with a container bed rotatably or tiltably attached to the frame of the motor vehicle.

Broadly stated, in some embodiments, an apparatus is provided for conveying bulk material, comprising: a trailer comprising a trailer bed configured for tilting from a substantially horizontal position to an inclined position; a container configured for containing the bulk material, the container disposed on the trailer bed, the container further comprising a gate at one end wherein when the trailer bed is in the inclined position and the gate is open, bulk material can exit the container; and a pneumatic conveyor disposed on the trailer, the conveyor further comprising a hopper disposed underneath the gate wherein the hopper receives bulk material disposed in the container exiting therefrom.

Broadly stated, in some embodiments, a motor vehicle is provided for transporting and conveying bulk material, comprising: a frame comprising a plurality of wheels rotatably disposed on the frame, a motor disposed in the frame, means for delivering power from the motor to at least of the plurality of wheels wherein the motor vehicle is capable of movement, and an operator's cab disposed on the frame configured to operate the motor vehicle; a container bed, the container bed configured for tilting from a substantially horizontal position to an inclined position; a container configured for containing the bulk material, the container disposed on the container bed, the container further comprising a gate at one end wherein when the container bed is in the inclined position and the gate is open, bulk material can exit the container; and a pneumatic conveyor disposed on the trailer, the conveyor further comprising a hopper disposed underneath the gate wherein the hopper receives bulk material disposed in the container exiting therefrom.

Broadly stated, in some embodiments, a method is provided for conveying bulk material disposed in a container, the method comprising the steps of: providing an apparatus for conveying bulk material, comprising: an end dump trailer comprising a trailer bed configured for tilting from a substantially horizontal position to an inclined position, the container disposed on the trailer bed, the container configured for containing the bulk material, the container further comprising a gate at one end wherein when the trailer bed is in the inclined position and the gate is open, bulk material can exit the container, and a pneumatic conveyor disposed on the trailer, the conveyor further comprising a hopper disposed underneath the gate wherein the hopper receives bulk material disposed in the container exiting therefrom; tilting the trailer bed to the inclined position; opening the gate wherein at least some of the bulk material contained in the container exits therefrom through the gate into the hopper; and operating the pneumatic conveyor to convey the bulk material in the hopper.

### BRIEF DESCRIPTION OF THE DRAWINGS

FIG. 1 is a side elevation view depicting one embodiment of an apparatus for conveying bulk materials with the trailer bed in a horizontal position.

FIG. 2 is a side elevation view depicting the apparatus of FIG. 1 with the trailer bed in an inclined position.

FIG. 3 is a schematic depicting a second embodiment of an apparatus for conveying bulk materials with the trailer bed in a horizontal position.

FIG. 4 is a side elevation view depicting the apparatus of FIG. 3 with the trailer bed in an inclined position.

FIG. 5 is a side elevation view depicting the container of the apparatus of FIG. 1.

FIG. 6 is a top plan view depicting the container of FIG. 5 with the top cover plate removed to show the structural elements therein.

FIG. 7 is a perspective view depicting a pneumatic conveyor for use with the apparatus of FIG. 1 or FIG. 3.

FIG. 8 is a side elevation view depicting the pneumatic conveyor of FIG. 7, certain portions of the same being cut away so as to show the internal feed auger.

FIG. 9 is a top plan view depicting the pneumatic conveyor of FIG. 7, a portion of the feed tube being cut away to show the feed auger and the flow control assembly for the hopper having been removed so as to also show the feed auger.

FIG. 10 is a top plan view depicting the hopper of the pneumatic conveyor of FIG. 7 with the flow control assembly in place above the feed auger.

FIG. 11 is a partial section view depicting the fluidizing chamber of the pneumatic conveyor of FIG. 7.

FIG. 12 is an end elevation view depicting the pneumatic conveyor of FIG. 7, a wall of the fluidizing chamber having been cut away so as to show the internal configuration thereof.

FIG. 13 is an end perspective view depicting an alternate embodiment of the container of FIG. 5.

FIG. 14 is an end perspective view depicting the container of FIG. 13 with a pneumatic conveyor enclosed with a cover butted against the container.

FIG. 15 is a side perspective view depicting the container of FIG. 14 with the cover pulled away from the container.

### DETAILED DESCRIPTION OF EMBODIMENTS

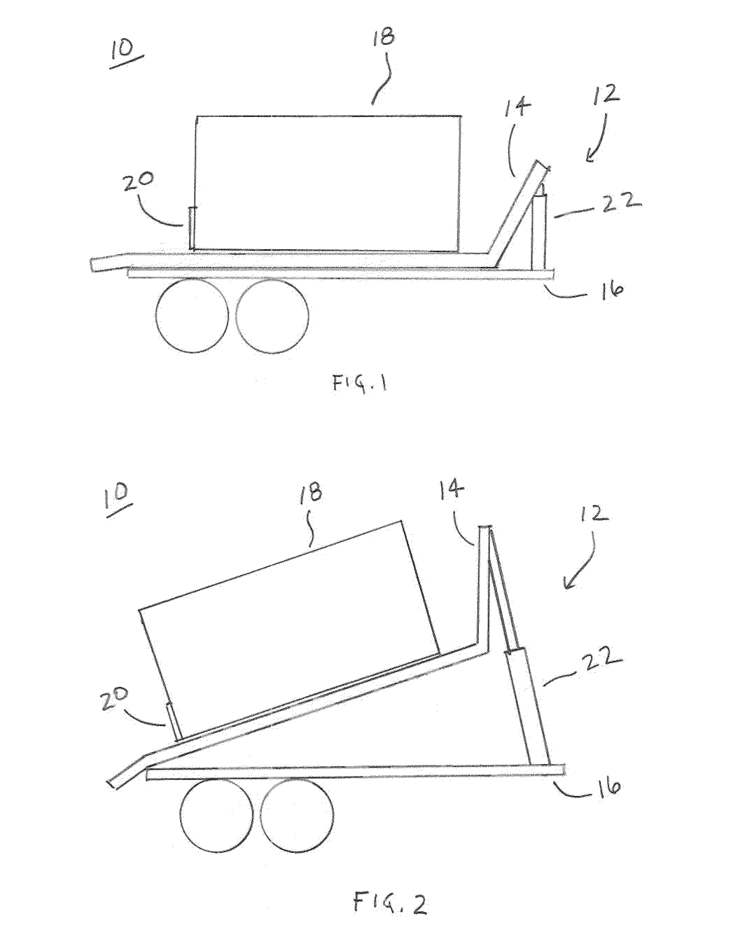

In some embodiments, an apparatus and method for conveying bulk materials is provided. Referring to FIGS. 1 and 2, in some embodiments, apparatus 10 can comprise trailer 12 further comprising frame 16 and trailer bed 14 rotatably attached thereto. In some embodiments, frame 16 can further comprise at least one axle and wheels rotatably attached thereto. Hydraulic ram 22 can provide means for raising trailer bed 14 from a substantially horizontal position, as shown in FIG. 1, to an inclined position, as shown in FIG. 2. Apparatus 10 can further comprise container 18 disposed on trailer 14 for containing granular and powered bulk materials. Container 18 can further comprise gate 20 disposed on one end thereof for providing an opening for the bulk materials to exit through.

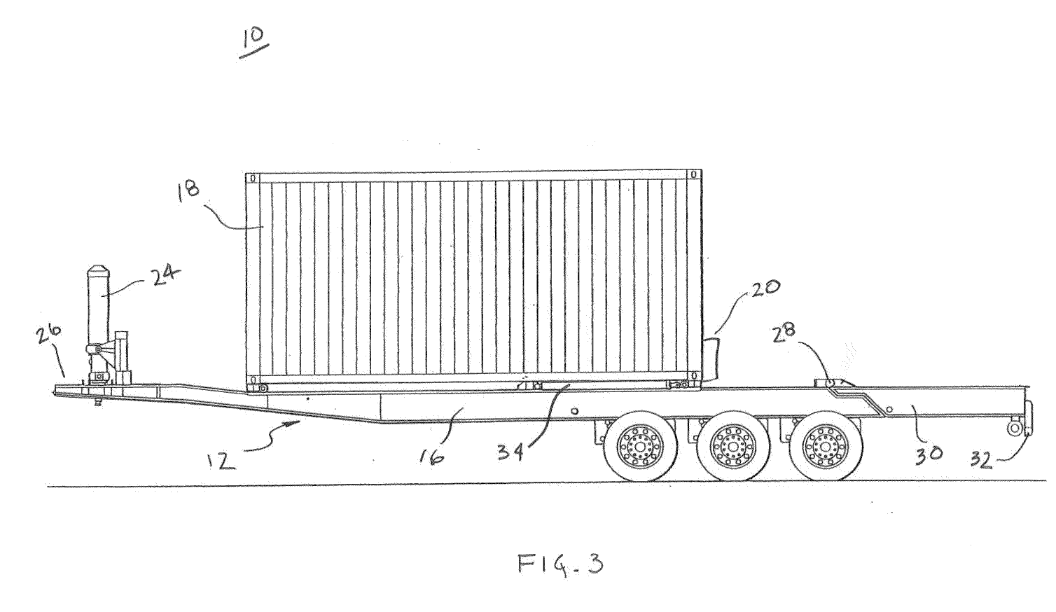

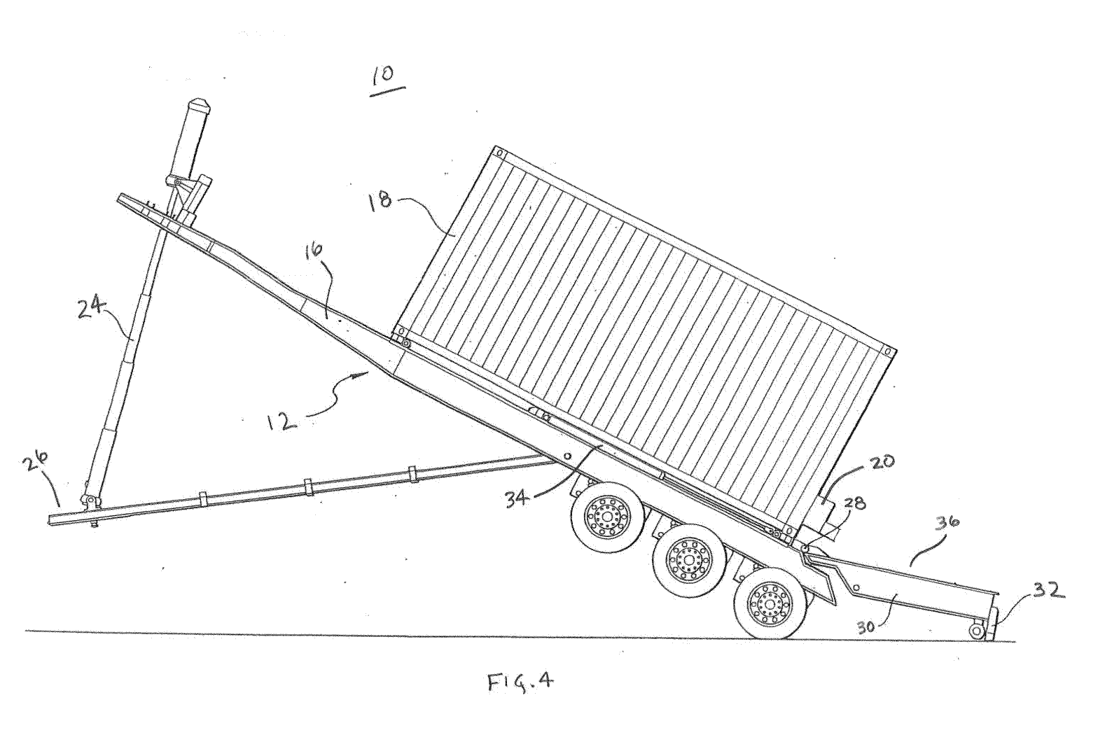

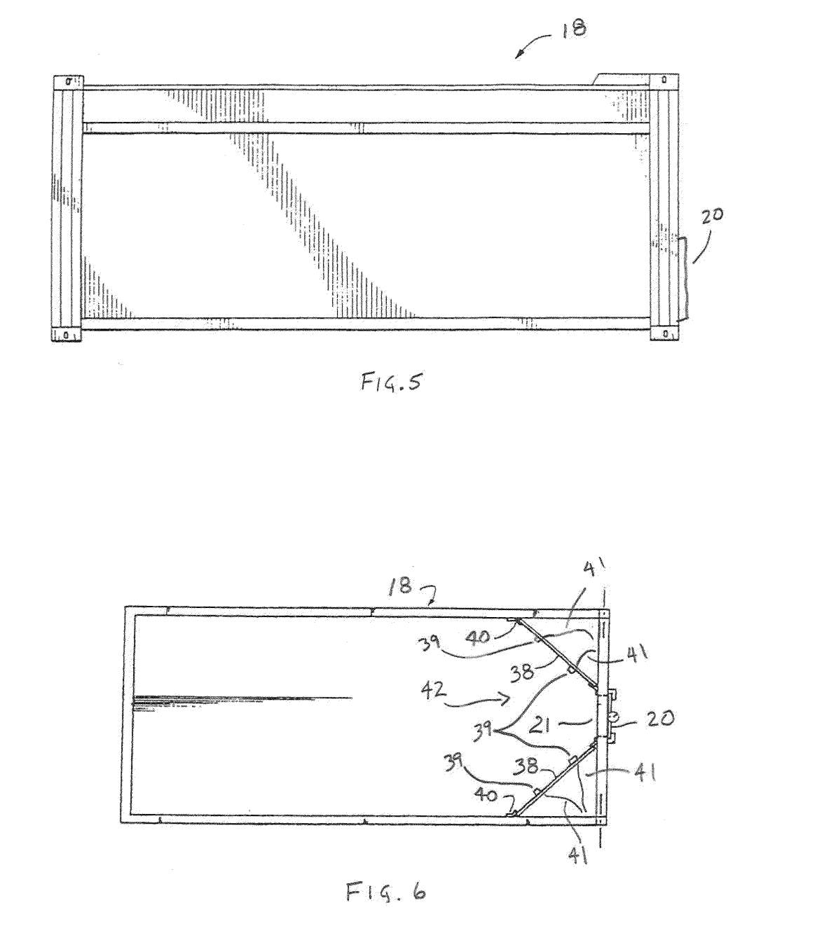

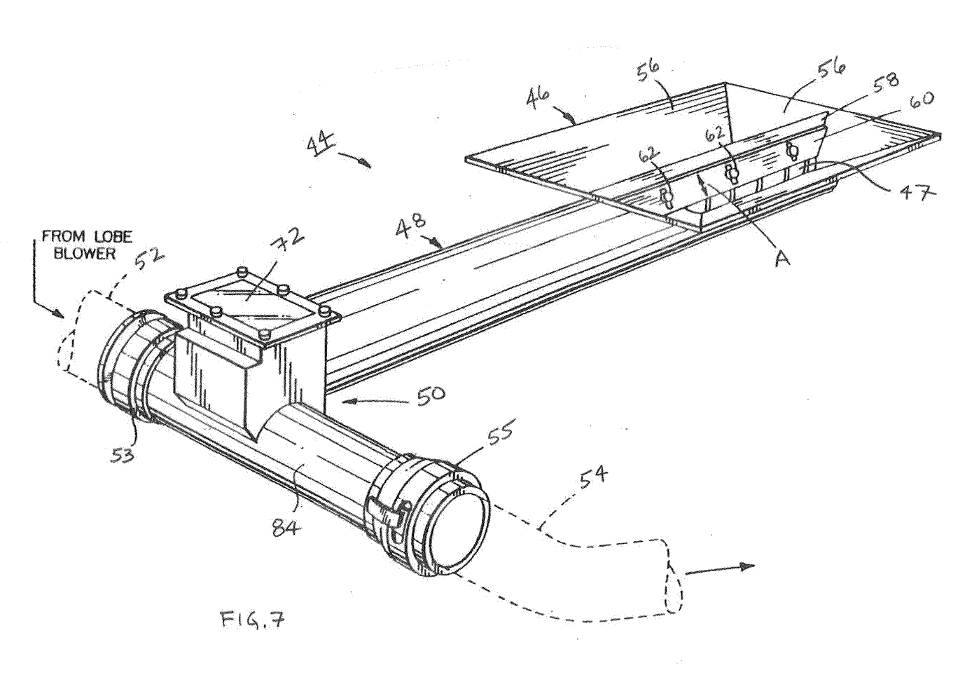

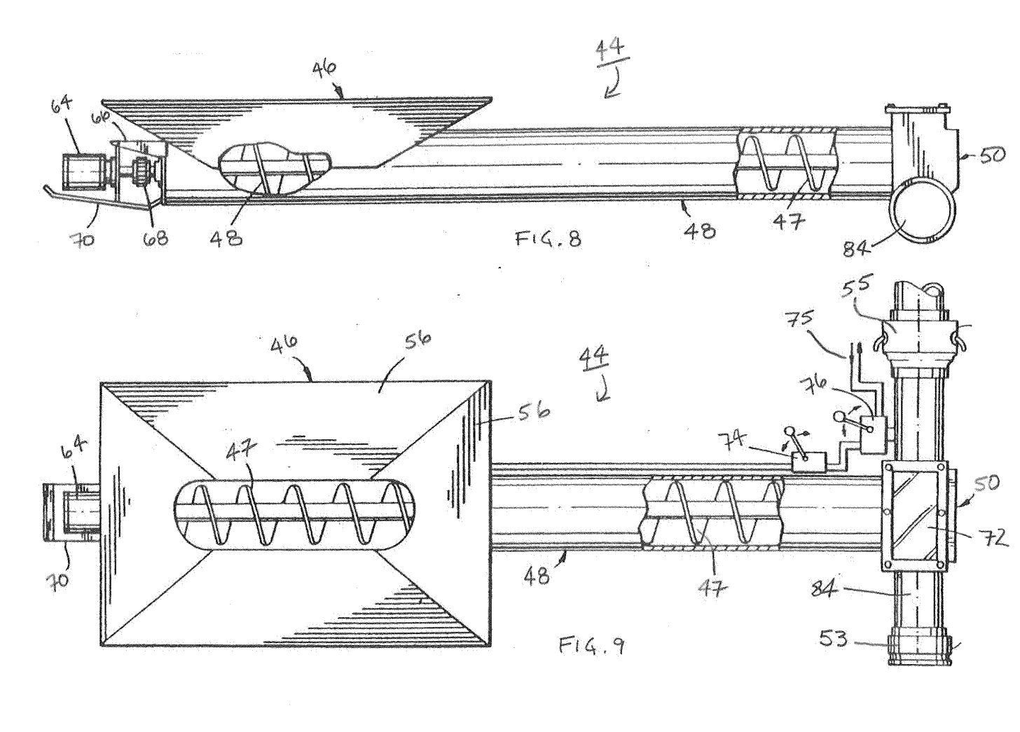

Referring to FIGS. 3 and 4, an alternate embodiment of apparatus 10 is shown. In this embodiment, trailer 12 can comprise rear portion 30 hingeably attached to frame 16 with hinge 28. Container 18 can be disposed on trailer bed 16. Trailer 12 can further comprise hitch 26, for attaching to a tractor or motor vehicle (not shown), and hydraulic ram 24 for raising trailer 12 from a substantially horizontal position, as shown in FIG. 3, to an inclined position, as shown in FIG. 4. In the inclined position, rear portion 30 rotates relative to frame 16 about hinge 28, and can be supported by the ground by support 32. In some embodiments, apparatus 10 can further comprise hydraulic ram 34 from moving container 18 from a forward position on trailer 12 for transport, as shown in FIG. 3, to a rearward position on trailer 12, as shown in FIG. 4. In the rearward position, gate 20 can be opened to allow bulk materials in container 18 to exit to a pneumatic conveyor (not shown) that can be placed on platform 36 of rear portion 30. It is obvious to those skilled in the art that while trailer 12 can be a stand-alone unit, as shown in FIGS. 1 to 4, to be towed by a tractor or motor vehicle (not shown), in some embodiments, frame 16 can be integral to the frame of a motor vehicle (not vehicle) and that trailer bed 14, as shown in FIGS. 1 and 2, can be rotatably attached to the motor vehicle frame.

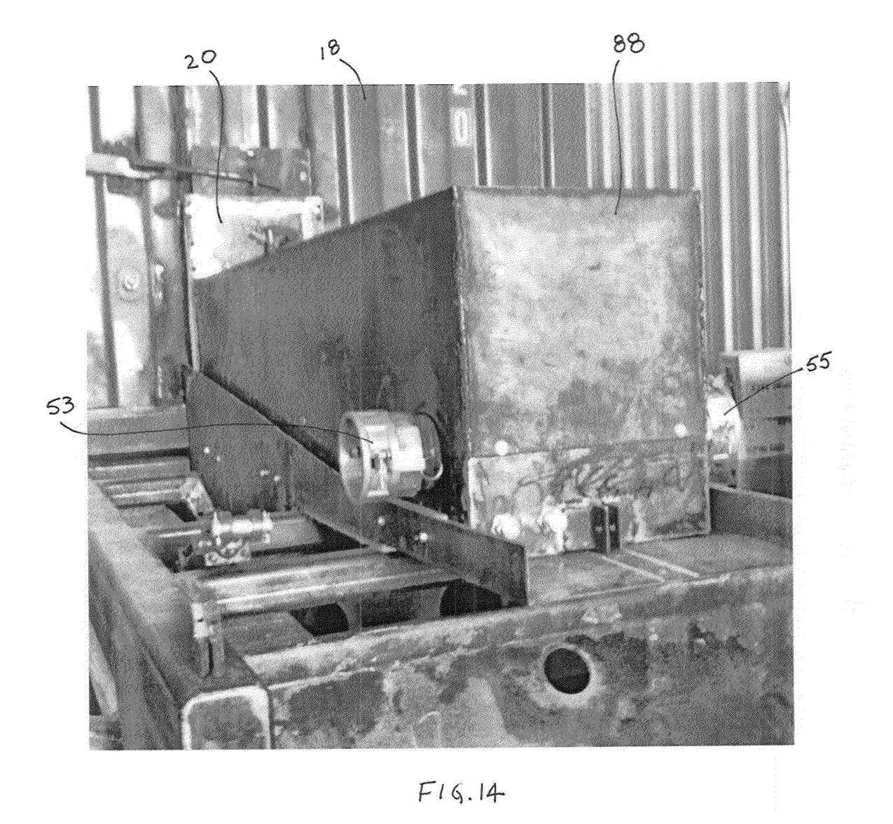

Referring to FIGS. 5 and 6, container 18 is shown. In some embodiments, container 18 can comprise a standard 8′×8′×20′ shipping container, as well known to those skilled in the art, which can enable the storage and transport of the bulk material using existing storage and logistics means as commonly used in the logistics industry. Container 18 can have gate 20 disposed on one end thereof. In some embodiments, gate 20 can be a sliding sheet that can travel in guides disposed on either side of an opening in and end wall of container 18, although other configurations can be used as well known to those skilled in the art. Referring to FIG. 6, container 18 can comprise, in some embodiments, vertical walls 38 that can be secured to the interior walls of container 18 with brackets 40. Alternatively, vertical walls 38 can be welded to the interior walls of container 18 or can be attached in any other way as well known to those skilled in the art. Vertical walls 38 can be configured to form funnel 42 for bulk material to flow towards and through gate 20. In some embodiments, container 18 can further comprise means for fluidizing the bulk material stored inside container 18 to make the bulk material to flow like a fluid so as to make it easier for the bulk material to flow through gate 20. For an example, it is well known that cement can be a fine powder and can settle into a solid mass when stored for periods of time. By injecting air or an inert gas into the cement, the cement can behave like a fluid and flow as such. In some embodiments, the means for fluidizing the bulk material can comprise one or more aeration paths 39 disposed on walls 38. Aeration paths 39 can be supplied with a source of compressed air or gas (not shown) via hoses 41 operatively coupling aeration paths 39 to the source of compressed air or gas. Referring to FIG. 13, another embodiment of container 18 is shown. In some embodiments, container 18 can further comprise one or more closable openings 19 disposed on a wall thereon. Openings 19 can comprise hose coupling fittings and can be used for coupling to a source of bulk material fed through a hose coupled thereto to fill container 18 with the bulk material. Another opening 19 can be disposed on container 18 and opened to act as a vent when bulk material is being fed into container 18 through the other opening 19. Once container 18 has been filled with bulk material, openings 19 can be closed.

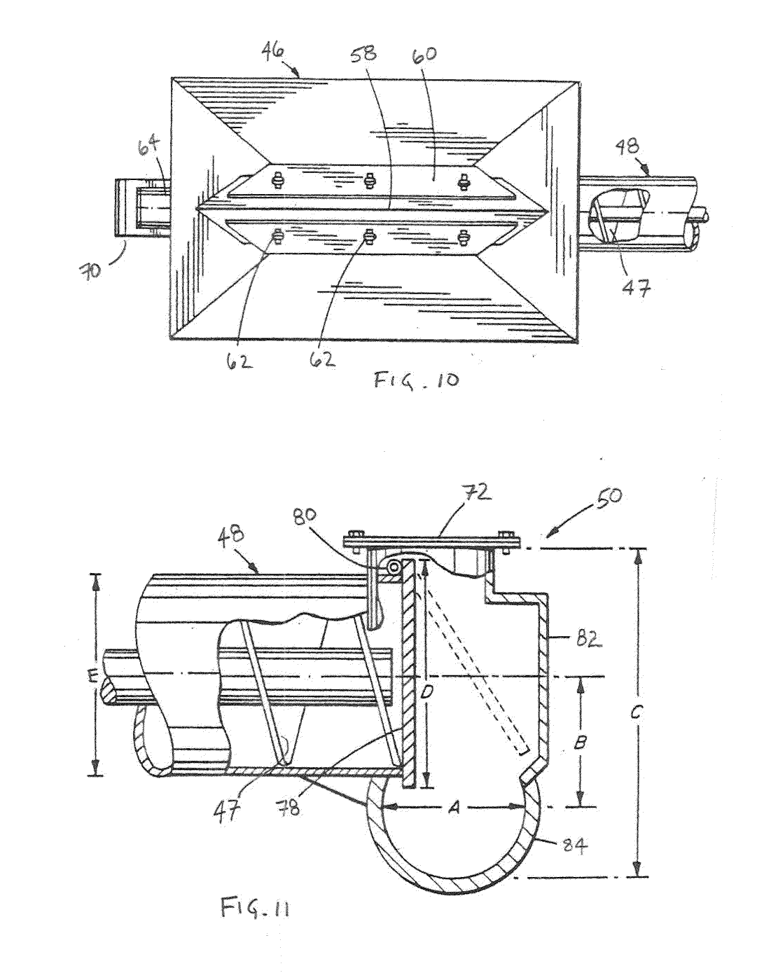

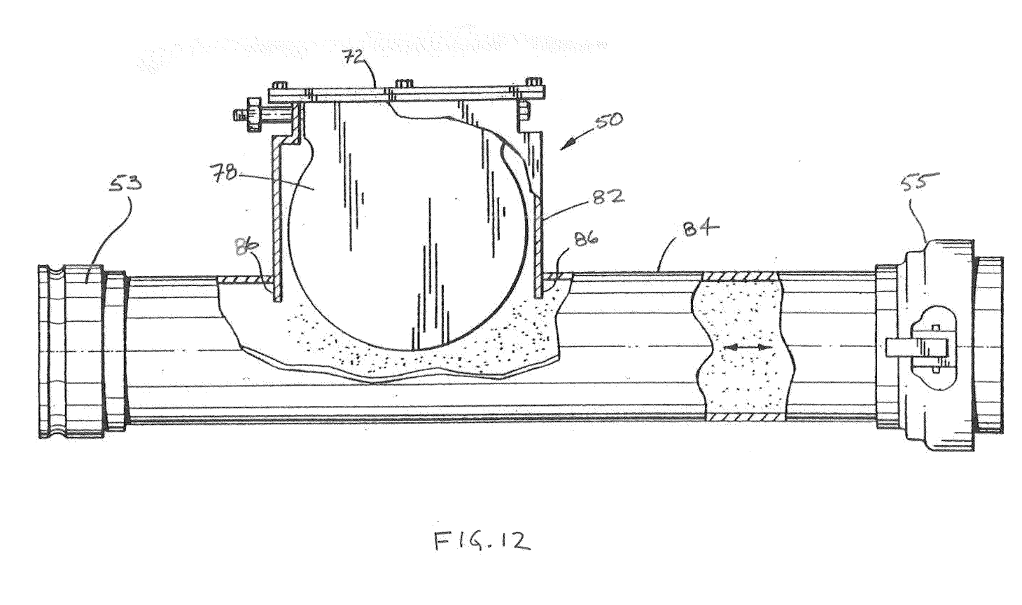

Referring to FIGS. 7 to 12, some embodiments of pneumatic conveyor 44 for use with apparatus 10 is shown. In some embodiments, conveyor 44 can comprise hopper 46 having sloping sidewalls 56, wherein hopper 46 feeds into feed tube 48 that is coupled to and in communication with fluidizing chamber 50. Hopper 46 can be configured to receive bulk material. In some embodiments, hopper 46 can further comprise baffle 58 disposed therein and adjustment plates 60 attached to baffle 58 with one or more fasteners 62. Adjustment plates 60 can be moved up or down relative to baffle 58 to adjust the size of the opening in hopper 46 to auger 47. In some embodiments, auger 47 disposed in feed tube 48 can move bulk material from hopper 46 through feed tube 48 to fluidizing chamber 50, that is in communication with air duct 84, further comprising inlet coupler 53, which can be connected to inlet air line 52, and outlet coupler 55, which can be connected to outlet air line 54. In some embodiments, fluidizing chamber 50 can further comprise sight glass 72 to permit visual inspection therein. In some embodiments, conveyor 44 can comprise hydraulic motor 64 connected to auger 47 via flex coupler 68 as means to rotate auger 47, as shown in FIGS. 8 and 9, although it is obvious to those skilled in the art that alternative motors, such as electric motors, pneumatic motors or internal combustion motors, as well known to those skilled in the art, that can be used as means to rotate auger 47. In some embodiments, motor 64 can be protected by skid plate 70, and held in place by motor bracket 66. In some embodiments, motor 64 can be operated and controlled with hydraulic valve 74, which can be configured to control the direction motor 64 turns, and with hydraulic valve 76, which can be configured to control speed at which motor 64 turns. Valves 74 and 76 can be connected to a source of pressurized hydraulic fluid via hydraulic hoses 75, as well known to those skilled in the art.

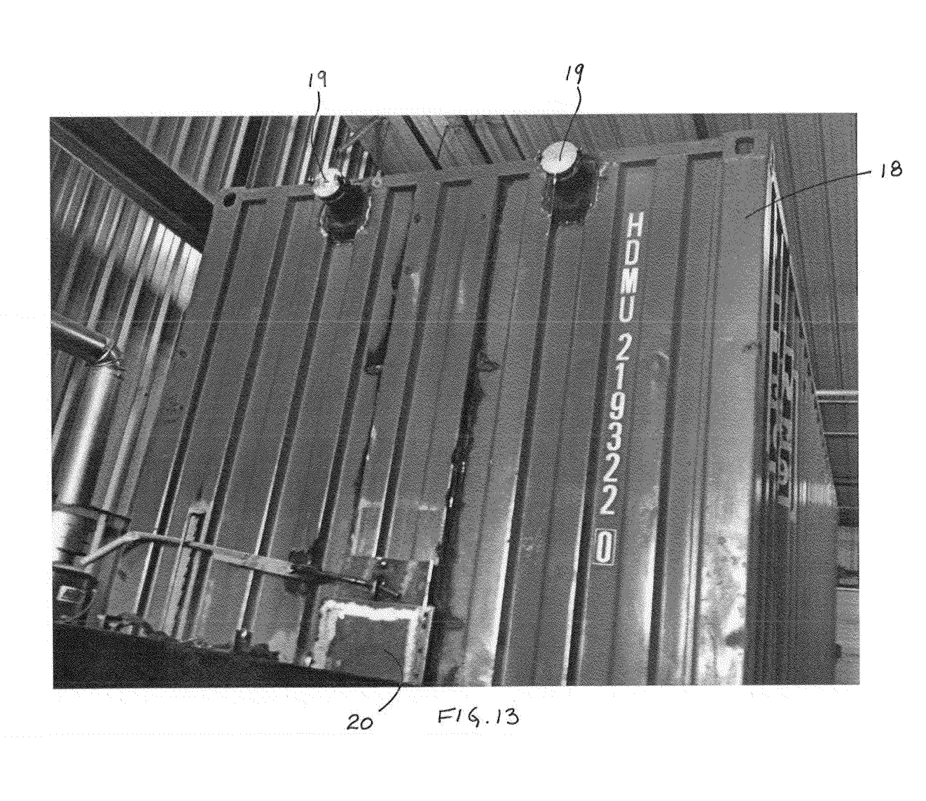

Referring to FIG. 11, in some embodiments, bulk material can be conveyed by auger 47 through feed tube 48 from hopper 46 into fluidizing chamber 50 wherein the rotation of auger 47 can move the bulk material against flap 78, which can then open by rotating about hinge 80 thereby allowing bulk material to enter box section 82 of fluidizing chamber 50 and fall into air duct 84. A source of compressed air flowing through air duct 84 can then move the bulk material from fluidizing chamber 50. In some embodiments, the source of compressed air can be connected to air duct 84 via coupler 53 wherein the compressed air can flow through air duct 84 and fluidizing chamber 50 and exit air duct 84 through coupler 55, as shown in FIG. 12. Baffles 86 disposed and extending downwardly into fluidizing chamber 50 can help create turbulence and assist in fluidizing the bulk material as the compressed air moves through air duct 84.

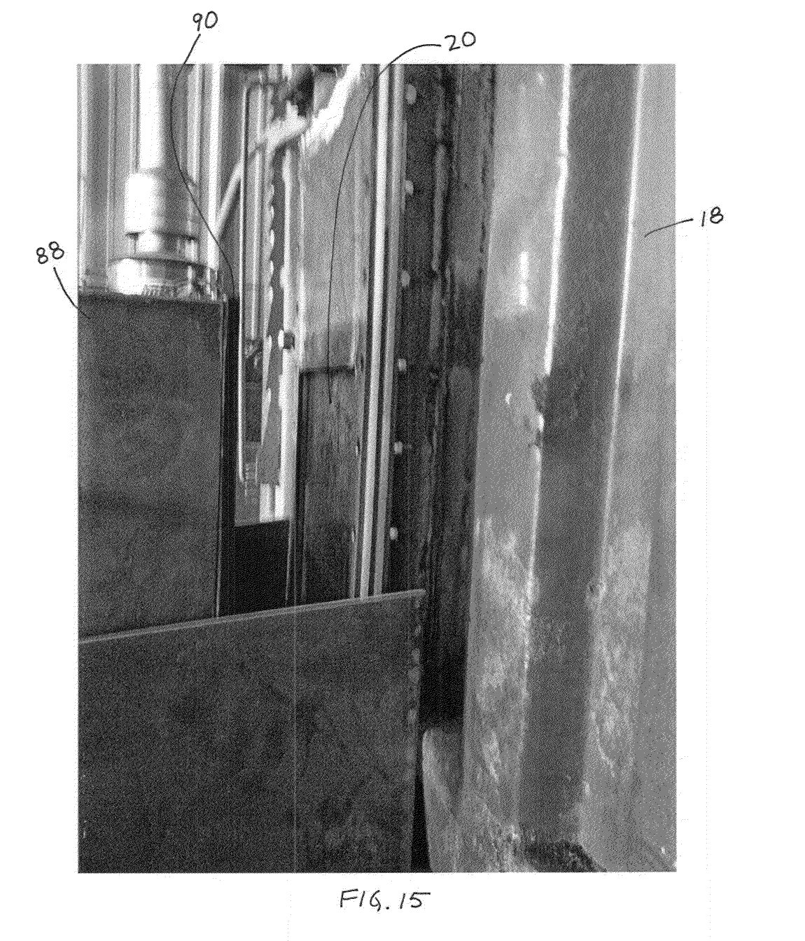

In some embodiments, apparatus 10 can further comprise cover 88 to enclose a pneumatic conveyor, as shown in FIG. 14. Cover 88 can be configured to allow couplers 53 and 55 to be exposed, and to slide against container 18 and press against and fully enclose gate 20. In so doing, cover 88 can contain bulk material exiting container 18 through gate 20 and direct the bulk material towards hopper 46 of conveyor 44, as a means to minimize any loss of bulk material exiting container 18. Referring to FIG. 15, cover 88 is shown pulled away from container 18 to reveal seal 90 disposed around the edges of cover 88 that can contact container 18 when cover 88 is placed against container 18. In some embodiments, seal 90 can comprise a foam rubber or an elastomeric strip, or any other functionally equivalent means well known to those skilled in the art, that can act to provide a positive seal between cover 88 and container 18 and minimize any loss of bulk material exiting container 18.

In operation, in some embodiments, a pneumatic conveyor, such as conveyor 44 shown in FIGS. 7 to 12, can be placed adjacent to gate 20. Conveyor 44 can be disposed on a stand-alone frame, or it can be disposed on an extension (not shown) of frame 16, as shown on FIG. 1. In other embodiments, conveyor 44 can be disposed on platform 36, as shown in FIG. 4. In some embodiments, apparatus 10 can further comprise means for moving conveyor 44 towards container 18 so that cover 88 contacts container 18, and for drawing conveyor 44 away from container 18. When container 18 is full with bulk material, container 18 can be maintained in a substantially horizontal position, as shown in FIG. 1. When gate 20 is opened as bulk material will have the tendency to flow naturally via gravity through gate 20 and into hopper 46 of conveyor 44. Auger 47 will move bulk material fed into hopper 46 through feed tube 48 into fluidizing chamber 50 through flap 78. Compressed air flowing through air duct 84 from coupler 53 to coupler 55 can move the bulk material through outlet air line 54 to the destination of where the bulk materials is to be placed. As container 18 becomes depleted of bulk material, trailer bed 14 can be raised to an inclined position, as shown in FIG. 2, to allow the bulk material flow through out of container 18 through gate 20 via gravity until empty. Trailer bed 14 can then be lowered to the horizontal position wherein the now empty container 18 can be removed from trailer 12 so that another container 18 filled with bulk material can be placed on trailer 12 wherein the bulk material in container 18 can be conveyed therefrom.

Although a few embodiments have been shown and described, it will be appreciated by those skilled in the art that various changes and modifications might be made without departing from the scope of the invention. The terms and expressions used in the preceding specification have been used herein as terms of description and not of limitation, and there is no intention in the use of such terms and expressions of excluding equivalents of the features shown and described or portions thereof, it being recognized that the invention is defined and limited only by the claims that follow.

What is claimed is:

1. An apparatus for conveying bulk material, comprising:
a) a trailer comprising a trailer bed configured for tilting from a substantially horizontal position to an inclined position;
b) a container configured for containing the bulk material, the container disposed on the trailer bed, the container further comprising a gate at one end wherein when the trailer bed is in the inclined position and the gate is open, bulk material can exit the container; and
c) a pneumatic conveyor disposed on the trailer, the conveyor further comprising a hopper disposed underneath the gate wherein the hopper receives bulk material disposed in the container exiting therefrom.

2. The apparatus as set forth in claim 1, wherein the trailer comprises an end dump trailer.

3. The apparatus as set forth in claim 1, wherein the trailer further comprises means for moving the container along the trailer bed.

4. The apparatus as set forth in claim 1, wherein the trailer further comprises means for moving the pneumatic conveyor to and from the container.

5. The apparatus as set forth in claim 1, wherein the container comprises an enclosed container.

6. The apparatus as set forth in claim 5, wherein the enclosed container comprises a standard shipping container.

7. The apparatus as set forth in claim 1, wherein the container further comprises vertical walls disposed therein configured to funnel the bulk material in the container towards the gate.

8. The apparatus as set forth in claim 1, further comprising means for fluidizing the bulk material in the container.

9. The apparatus as set forth in claim 7, further comprising means for fluidizing the bulk material in the container.

10. The apparatus as set forth in claim 9, wherein the fluidizing means comprises at least one aeration path disposed on the vertical walls configured to inject pressurized air or gas into the container to aid in the flow of the bulk material towards the gate.

11. The apparatus as set forth in claim 1, further comprising a cover for the pneumatic conveyor, the cover configured to enclose the pneumatic conveyor and to contain the flow of bulk material from the container to the hopper.

12. A motor vehicle for transporting and conveying bulk material, comprising:
a) a frame comprising a plurality of wheels rotatably disposed on the frame, a motor disposed in the frame, means for delivering power from the motor to at least of the plurality of wheels wherein the motor vehicle is capable of movement, and an operator's cab disposed on the frame configured to operate the motor vehicle;
b) a container bed, the container bed configured for tilting from a substantially horizontal position to an inclined position;
c) a container configured for containing the bulk material, the container disposed on the container bed, the container further comprising a gate at one end wherein when the container bed is in the inclined position and the gate is open, bulk material can exit the container; and
d) a pneumatic conveyor disposed on the frame, the conveyor further comprising a hopper disposed underneath the gate wherein the hopper receives bulk material disposed in the container exiting therefrom.

13. The vehicle as set forth in claim 12, wherein the motor vehicle comprises a tractor and a trailer, the tractor further comprising the frame, the motor, the power delivering means and the operator's cab, the trailer further comprising the container bed.

14. The vehicle as set forth in claim 12, wherein the frame comprises an end dump trailer.

15. The vehicle as set forth in claim 12, wherein the frame further comprises means for moving the container along the container bed.

16. The vehicle as set forth in claim 12, wherein the frame further comprises means for moving the pneumatic conveyor to and from the container.

17. The vehicle as set forth in claim 12, wherein the container comprises an enclosed container.

18. The vehicle as set forth in claim 17, wherein the enclosed container comprises a standard shipping container.

19. The vehicle as set forth in claim 12, wherein the container further comprises vertical walls disposed therein configured to funnel the bulk material towards the gate.

20. The vehicle as set forth in claim 12, further comprising means for fluidizing the bulk material in the container.

21. The vehicle as set forth in claim 19, further comprising means for fluidizing the bulk material in the container.

22. The vehicle as set forth in claim 21, wherein the fluidizing means comprises at least one aeration path disposed on the vertical walls configured to inject pressurized air or gas into the container to aid in the flow of the bulk material towards the gate.

23. The vehicle as set forth in claims 12, further comprising a cover for the pneumatic conveyor, the cover configured to enclose the pneumatic conveyor and to contain the flow of bulk material from the container to the hopper.

24. A method for conveying bulk material disposed in a container, the method comprising the steps of:
a) providing an apparatus for conveying bulk material, comprising:
i) an end dump trailer comprising a trailer bed configured for tilting from a substantially horizontal position to an inclined position,
ii) the container disposed on the trailer bed, the container configured for containing the bulk material, the container further comprising a gate at one end wherein when the trailer bed is in the inclined position and the gate is open, bulk material can exit the container, and
iii) a pneumatic conveyor disposed on the trailer, the conveyor further comprising a hopper disposed underneath the gate wherein the hopper receives bulk material disposed in the container exiting therefrom;
b) tilting the trailer bed to the inclined position;
c) opening the gate wherein at least some of the bulk material contained in the container exits therefrom through the gate into the hopper; and
d) operating the pneumatic conveyor to convey the bulk material in the hopper.

25. The method as set forth in claim 24, wherein the trailer comprises an end dump trailer.

26. The method as set forth in claim 24, wherein the trailer further comprises means for moving the container along the trailer bed.

27. The method as set forth in claim 24, wherein the trailer further comprises means for moving the pneumatic conveyor to and from the container.

28. The method as set forth in claim 24, wherein the container comprises an enclosed container.

29. The method as set forth in claim 28, wherein the enclosed container comprises a standard shipping container.

30. The method as set forth in claim 24, wherein the container further comprises vertical walls disposed therein configured to funnel the bulk material in the container towards the gate.

31. The method as set forth in claim 24, wherein the apparatus further comprises means for fluidizing the bulk material in the container.

32. The method as set forth in claim 30, wherein the apparatus further comprises means for fluidizing the bulk material in the container.

33. The method as set forth in claim 32, wherein the fluidizing means comprises at least one aeration path disposed on the vertical walls configured to inject pressurized air or gas into the container to aid in the flow of the bulk material towards the gate.

34. The method as set forth in claim 24, wherein the apparatus further comprises a cover for the pneumatic conveyor, the cover configured to enclose the pneumatic conveyor and to contain the flow of bulk material from the container to the hopper.
